(19) United States
(12) Patent Application Publication
(10) Pub. No.: US 2026/0270515 A1
(43) Pub. Date: Sep. 10, 2026

(54) CLIENT-SIDE MANIFEST MANIPULATOR

(71) Applicant: INVIDI TECHNOLOGIES CORPORATION, PRINCETON, NJ (US)

(72) Inventors: Erik ERIKSSON, Princeton, NJ (US); Jeremy KOOPMANS, Princeton, NJ (US); Akhilesh TELIKICHERLA, Princeton, NJ (US)

(21) Appl. No.: 19/072,751

(22) Filed: Mar. 6, 2025

(51) Int. Cl. H04N 21/462; H04N 21/44; H04N 21/442

(52) U.S. Cl. CPC H04N 21/462; H04N 21/44016; H04N 21/442

(57) ABSTRACT

A system and associated functionality are disclosed for delivering addressable content, such as addressable advertising, in connection with content streams such as live video streams, video-on-demand streams, or recorded video/DVR streams. A streaming system (100) includes content server (120) and client device (110) for delivering streaming content to a user. The client device (110) includes a manifest manipulator (112), a media player (114), and a media playout technology (116). The manifest manipulator (112) reads ahead in the manifest to identify an asset delivery opportunity, such as an addressable advertising spot, in advance of the asset delivery opportunity and modifies the manifest file to identify an asset to be delivered in the asset delivery opportunity. The manifest manipulator (112) can then provide the modified manifest to the media player (114) which uses the modified manifest to format the content stream for delivery to a user or users via the media playout technology (116).

### FIELD OF THE INVENTION

The present invention relates generally to delivering addressable content in insertion opportunities of content streams (e.g., an ad break of a live video stream) and, in particular, to a client-side manifest manipulator for insertion of targeted advertisements in over-the-top (“OTT”), Internet Protocol Television (“IPTV”), or other streaming content.

### BACKGROUND OF THE INVENTION

Traditionally, television programming was distributed through terrestrial, satellite, and cable television formats. In this regard, a content stream containing television shows, movies, advertisements, public service announcements, etc. was continuously transmitted and viewed in a substantially real-time manner as scheduled (in a “live” or “linear” manner) at a viewer's television.

In recent years, with the proliferation of digital television and streaming platforms, alternative conduits for accessing television programming have emerged. Some of these are linear, in which the content stream is viewed in real-time like traditional systems, and others are non-linear (e.g., time-shifted viewing using a digital video recorder or “DVR”, video-on-demand, etc.). OTT and IPTV have both gained widespread appeal as delivery methods utilizing the Internet Protocol over a packet-switched network. Generally, the difference between the two protocols is that OTT typically utilizes open internet channels whereas IPTV generally is offered over a dedicated infrastructure. Notably, both may be linear or non-linear. Furthermore, the present invention may be applicable in the context of various streaming formats including manifest-based video streaming where a manifest (e.g., a file or set of instructions) is used to define or control how a video stream is structured or delivered and, for convenience, such contexts are referred to herein as streaming.

In the context of linear streaming, a viewer may receive and view a content stream at substantially the same time as a viewer receiving the content stream in a traditional fashion. It will be appreciated that linear streaming may be delayed by a short time interval, perhaps as long as 30-60 seconds in some cases. For example, a viewer receiving a satellite broadcast may be tuned into NBC to watch a television program while an OTT user may watch an identical NBC broadcast on an internet-enabled device (e.g., smartphone, tablet computer, PC, Smart TV, set-top box, game console, etc.) at the same time. Television shows or televised events may be synchronized across millions of devices accessing the stream via the internet.

Generally, in digital television, a content stream is embodied in a digital container format for transmission and storage. Although a variety of digital container formats exist and may be applicable in the context of the present invention (e.g., 3GP, AVI, Flash, etc.), an MPEG transport stream (“MPEG-TS”) is widely used as a standard container for digital broadcasting, Blu-Ray, etc. and therefore the present invention is often discussed below in the context of MPEG-TS. However, it will be appreciated that various aspects of the invention are applicable independent of the underlying video packets and may be implemented, for example, in other adaptive streaming contexts such as fragmented mp4. An MPEG-TS may be simultaneously distributed via traditional means and streaming such as OTT and IPTV. In the latter regard, the MPEG-TS may be segmented into file chunks (e.g., 5-10 seconds each) for individual download to end-user devices. A manifest file may be created and subsequently accessed by or downloaded to the devices. Such a manifest file may provide the devices with addresses at which the file chunks may be retrieved as well as presentation time stamps (“PTSs”) for synchronization. The manifest file is used by the client device to enable streaming playback of a content stream.

Broadcast network content or programming is commonly provided in conjunction with associated informational content or assets. These assets include advertisements, associated programming, public-service announcements, ad tags, weather or emergency notifications and a variety of other content, including paid and unpaid content. Asset providers (e.g., advertisers) who wish to convey information (e.g., advertisements) regarding services and/or products to users of the broadcast network often pay for the right to insert their information into programming of the broadcast network. For instance, advertisers may provide ad content to a network operator such that the ad content may be interleaved with a content stream during one or more ad breaks.

To achieve a better return on their investment, asset providers often try to target their assets to a selected audience that is believed to include potential consumers of the asset provider. The case of advertisers on a cable television network is illustrative. For instance, an advertiser or a cable television network may target its ads to certain demographic groups based on, for example, geographic location, gender, age, income, etc. Accordingly, once an advertiser has created an ad that is targeted to a desired group of viewers (e.g., targeted group) the advertiser may attempt to procure insertion times in the network programming when the targeted group is expected to be among the audience of the content stream.

In some broadcast networks (e.g., such as those in the United States), one or more ad cues (e.g., SCTE 35 or 104) may also be incorporated into the content stream. Such ad cues have allowed network platforms (e.g., local head ends) to identify upcoming ad breaks in the programming contained in the national feed. Accordingly, such local head ends may replace content within the national feed with an asset that is better suited for a local audience. Other technologies may be used to identify insertion opportunities including content recognition technologies for providing ad break markers. Any information used to identify an insertion opportunity is included in “cues” as used herein.

In recent years, technological advancements have enabled advertisers to target advertisements to more specific levels of granularity. In the case of addressable advertising, different viewers of a given program, even within a particular network subdivision, may receive different ads while viewing the same channel and program. This allows ads to be targeted based on location parameters independent of network topology, demographics, psychographics, or other targeting parameters of interest to an advertiser. Households or an individual user or users may be targeted based on classification parameters inferred from interaction with a device, an identity or characteristics determined by sensors, information from network or third-party databases and/or other information sources including, but not limited to, past purchase data, browser history, credit report, income, gender, personal interests, etc. (collectively, “consumer data”).

In the context of streaming, an ad cue, which may be included in a manifest file, may signal a device streaming an MPEG-TS to send a request to an ad decision engine. The ad decision engine may evaluate consumer data associated with the device to determine an appropriate asset for insertion during an upcoming ad break. In some instances, a selected advertisement may then be downloaded to the device. In other instances, multiple assets may be downloaded to the device in advance and the ad decision engine may instruct the device which asset to display and which assets to ignore or discard. In yet other instances, an ad decision engine may instruct the device to stream a particular asset by providing an address at which the asset may be streamed.

Addressable advertising has been challenging to implement in livestreaming contexts. One approach involves generating specialized manifest files for delivery with the content stream from a content server (server-side systems) to the devices or players of the user (user side devices). Such a system is described in U.S. patent application Ser. No. 16/600,262 entitled “Method and Apparatus for Combining Metadata and Content Stream Manifest Files for Processing on Client Devices,” which is incorporated herein by reference. This involved separation of the MPEG stream into data messages and AV content, modifying the data messages, and combining the modified content stream message data and the content stream manifest files into combined manifest files. The combined manifest files could then be accessed by the client devices to download addressable assets for insertion into the content stream. However, this required significant effort and expense to modify server-side systems which could be impractical in some cases. Moreover, this solution was difficult to scale for high-volume events. Because of the size of a streaming audience is not known in advance, systems were often over-engineered to ensure adequate performance, thus further increasing expenses. Moreover, some server-side solutions do not know the position of the user side devices and have to approximate tracking information of ad playout. As a result, addressable advertising has made limited penetration in linear streaming contexts.

### SUMMARY OF THE INVENTION

The present invention is directed to a system and associated functionality (“utility”) for delivering addressable content, such as addressable advertising, in connection with content streams such as live or linear video streams, as well as video-on-demand (VOD) and recorded video/DVR contexts. The invention implements client-side manifest manipulation to generate a modified manifest for delivery to the client media player, where the modified manifest concerns an addressable asset. In this manner, the addressable content is delivered in content streams without requiring server-side manipulation of the manifest or stream. It will be appreciated that, on top of ad serving and content delivery network costs, server-side solutions incur costs independently of ad fill-rate and inventory volumes, while client-side solutions in accordance with the present invention may incur more limited costs related to ad serving and the content delivery network. The invention reduces costs of addressable asset delivery in streaming contexts, supports practical addressable asset delivery for various markets, scales to support high-volume streaming environments, and can be implemented using existing network infrastructure. For example, the inventive system does not require an additional media player for addressable asset insertion.

In accordance with one aspect of the present invention, a manifest manipulator is provided in connection with a client-side device such as a set-top box or other streaming device. An associated utility involves receiving, at the client device from a network content server, a content stream and a manifest concerning content portions of the content stream. As noted above, the manifest may include, among other things, addresses at which file chunks may be retrieved and PTSs. An insertion opportunity for addressable content is identified prior to a time of the insertion opportunity. For example, the insertion opportunity may be identified by accessing the manifest or via a separate file outside of the manifest. In some implementations, the manifest can be accessed without accessing the MPEG stream content. As noted above, in some live streaming contexts, delivery of the streaming content may be delayed by a short time, in some cases, up to 30-60 seconds. Accordingly, the inventive system can read-ahead to access the manifest before the delivery opportunity. In other contexts, the system may not read-ahead or may limit certain processing to breaks about to be watched. For example, one use case involves a cloud DVR window feature where the manifest may encompass a longer time window, e.g., several hours long, allowing the viewer to rewind within the manifest time period. In such cases, the system may leverage player position information to only execute certain processing for the breaks about to be watched, not throughout the whole manifest time period. The system can track what processing has been completed to maintain session consistency.

The utility further involves identifying an addressable asset for delivery in the insertion opportunity and inserting associated manifest information. This may involve removing manifest information for any underlying ads included in the original manifest and inserting manifest information for the identified addressable assets in its place. For example, the portion of the original manifest information corresponding to the underlying ads based on the length of the original cue may be removed. Then, the ad manifest information for the identified addressable ads is inserted in its place by transcoding ad files for the addressable ads into a compatible manifest format and associated MPEG-TS segments. The modified manifest is then delivered to the content player of the client device so that, based on the modified manifest, the content player plays the content stream with the addressable asset in the insertion opportunity.

The invention is applicable in a variety of streaming contexts including OTT and digital cable and satellite delivery systems. The client device may comprise a set-top box, a smart television, a desktop computer, a laptop computer, a phone, or a tablet computer, among other possibilities. The content stream may include audio and/or video content. The delivery opportunity may be associated with a cue, such as an SCTE cue, ad break marker, or other information identifying an addressable asset delivery opportunity. From the perspective of the client device, the device may be unaware that replacement of the original underlying ads with addressable ads has occurred. That is, the manifest points to consecutive video segments that need to be inserted. The modified manifest information points to a content delivery network for the addressable ads that may be the same as or different than that of the associated video content, but the client device reads the modified manifest as if it were part of the original content stream. The client device may identify the addressable asset by transmitting an asset delivery request to a decisioning system and receiving a playlist including the asset. Depending on the specific implementation, the asset may be obtained from the content server, from a separate asset server, or another source. The client device may further accurately monitor delivery of the asset by the client device and generate a report to a network platform as described in U.S. patent application Ser. No. 15/403,837, entitled “Cloud-Based Decisioning for Addressable Asset System,” now U.S. Pat. No. 10,523,992 (the “Cloud-Based Decisioning case”) and/or a centralized platform for processing reports received from devices of multiple content delivery networks (among other functionality) as described in U.S. patent application Ser. No. 17/659,420 entitled “Mediahub for Controlling and Monitoring the Distribution of Targeted assets,” now U.S. Pat. No. 12,069,326 (“the Mediahub Case”) both of which are incorporated herein by reference. Such reports may be used for billing, monitoring of fulfillment of an addressable asset delivery campaign, analysis of asset effectiveness, or other purposes. The report may simply identify the asset played or may include additional information such as whether a user tuned-away from the asset during play or any indication of interest by the user.

In accordance with another aspect of the present invention, server-side functionality is provided for use in delivering addressable content in a content stream of a streaming network.

The streaming method provides a manifest, in connection with the content stream, to facilitate playback of the content stream for a client device, where the client device includes a manifest manipulator to insert, into the manifest, manifest information concerning the addressable content. An associated utility involves providing, to the client device from a first network platform, the content stream and the manifest, where the client device is operative to insert, into the manifest, manifest information concerning the addressable content. The utility further involves receiving, from the client device at a second network platform, a report including delivery information concerning the addressable content. For example, the report may identify the addressable content delivered at the client device, identify programming or a programming network associated with the delivered addressable content, and/or indicate an amount of the addressable content delivered or a level of interest concerning the addressable content, among other things.

The second network platform may be the same as or different than the first network platform. For example, the first network platform may include a network content server. The second platform may include, for example, a platform of an addressable asset delivery system (e.g., as described in the Cloud-Based Decisioning Case), a platform of a business system (e.g., for monitoring fulfillment of an addressable asset delivery campaign, and/or a centralized platform such as described in the Mediahub Case. In this manner, client-side asset replacement can be efficiently implemented while maintaining network level monitoring of asset delivery.

### BRIEF DESCRIPTION OF THE DRAWINGS

For a more complete understanding of the present invention and further advantages thereof, reference is now made to the following Detailed Description, taken in conjunction with the drawings, in which:

FIG. 1 is a block diagram of a streaming system incorporating a client-side manifest manipulator in accordance with the present invention; and

FIG. 2 is a flow chart illustrating a process for delivering addressable content in a live streaming context in accordance with the present invention.

### DETAILED DESCRIPTION

In the following description, the invention is set forth in connection with a client-side manifest manipulator for use in inserting addressable assets in a live streaming or other streaming context, e.g., a multicast or unicast streaming context. While this is an advantageous application, the present invention is not limited to this specific context, or the specific examples described below. Accordingly, the following description should be understood as exemplary and not by way of limitation.

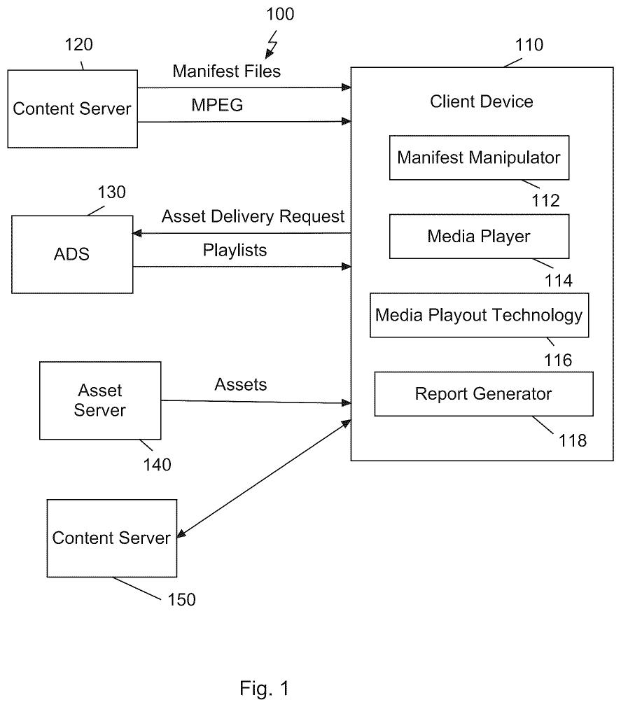

FIG. 1 Illustrates a streaming system 100 in accordance with the present invention. The illustrated system includes a client device 110 for delivering streaming content to a user or users and a content server 120 for delivering streaming content to the client device. Depending on the specific implementation, the content server 120 may be part of an OTT platform or may be part of a digital cable or satellite network, among other possibilities. The client device may be, for example, a set-top box, a smart TV, a desktop computer, a laptop computer, phone, a tablet computer, or other streaming device. The content stream may include audio and/or video content.

The illustrated content server 120 transmits a content stream and manifest files to the client device 110. The content stream may be, for example, an adaptive stream such as an HTTP Live Stream (HLS) for Apple devices or Dynamic Adaptive Stream over HTTP (DASH) stream for Android devices. The manifest files provide addresses for chunks of the content stream together with PTSs.

The client device 110 includes a manifest manipulator 112, a media player 114, a media playout technology 116, and a report generator 118. The manifest illustrated manipulator 112 receives the manifest files and reads ahead in the manifest files. That is, as noted above, live streams may be delayed for a short time, in some cases, up to 30-60 seconds. The manifest manipulator 112 can thus read the manifest files to identify an upcoming asset delivery opportunity, such as an addressable asset delivery opportunity (e.g., an addressable advertising spot), in advance of the asset delivery opportunity. Upon identifying an asset delivery opportunity, the client device 110 may transmit an asset delivery request to a decisioning system such an Ad Decisioning System (ADS) 130. The ADS 130 can select an asset based on consumer data such as classification parameters, e.g., demographic or other characteristics of a device user, constraints concerning which assets are available for delivery in connection with a particular asset delivery opportunity, and other rules. An example of an ADS is set forth in the Cloud-Based Decisioning case. The ADS 130 then transmits a playlist including one or more assets (e.g., asset identifiers or access information) to the client device 110.

The client device 110 also receives assets from an asset server 140. This may be implemented in various ways. For example, the asset server 140 may be the same as the content server 120 or may be a different source. In one implementation, the asset server is a separate source and the manifest files are manipulated to point to the asset server as described below. In any event, assets identified by the ADS 130 will be available for playout at the client device 110.

Upon receiving a playlist from the asset decisioning system 130, the manifest manipulator 112 may modify a manifest file to identify an asset to be delivered in connection with the upcoming asset delivery opportunity. For example, an address of the asset together with a PTS may be inserted into the manifest file. Manifest information concerning a default asset for the delivery opportunity (if included in the original content) may be deleted or replaced in this regard. Otherwise, information is simply added to the manifest.

The manifest manipulator 112 can then provide the modified manifest to the media player 114. For example, the media player may be a video player such as the ExoPlayer for Android media. From the perspective of the media player 114, the modified manifest is the same as any other manifest. The media player 114 uses the manifest to assemble the content stream for delivery to a user or users via the media playout technology 116. Depending on the implementation, the media playout technology 116 may include a television, a set-top box, a computer, a phone, or other data terminal. The media may include, for example, audio and or video content.

The report generator 118 monitors asset delivery at the client device 110 and provides reports concerning the delivered asset to a report processing platform 150. Various types of information may be included in the reports. For example, the reports may indicate that an asset was selected or delivered, or the report may indicate how much of the asset was delivered in cases where the asset did not play in full. Additionally, the reports may indicate an observed level of interest, e.g., relating to an increased or decreased volume setting during playout, any interaction with interactive elements, etc. The report may further include information about associated programming (e.g., what program was the client streaming when the asset was delivered) or programming network (the network that produced or streamed the associated programming). The reports may also include classification information for the user who received the asset or information (such as a user identification of a device identifier) that can be correlated to classification information.

The report processing platform 150 can be implemented in various ways. For example, the platform 150 may include a business system for monitoring and implementing an addressable asset delivery campaign. Such a campaign may have delivery constraints and goals. The constraints may concern how many total impressions may be delivered to a given user, how often an asset may be played, or constraints concerning a sequence of related assets, among other things. Campaign goals may relate to the overall number of impressions for all users desired during a campaign time period, a pacing of deliveries, a frequency of deliveries, and the like.

Additionally, or alternatively, the platform 150 may include a billing system, e.g., for billing asset providers (e.g., advertisers) for impressions delivered or an analytics system for analyzing the effectiveness of delivered assets. The platform 150 may receive and process reports for a single network (e.g., a wireless communications network, a data network, or a cable or satellite television network) or may receive and aggregate report across networks.

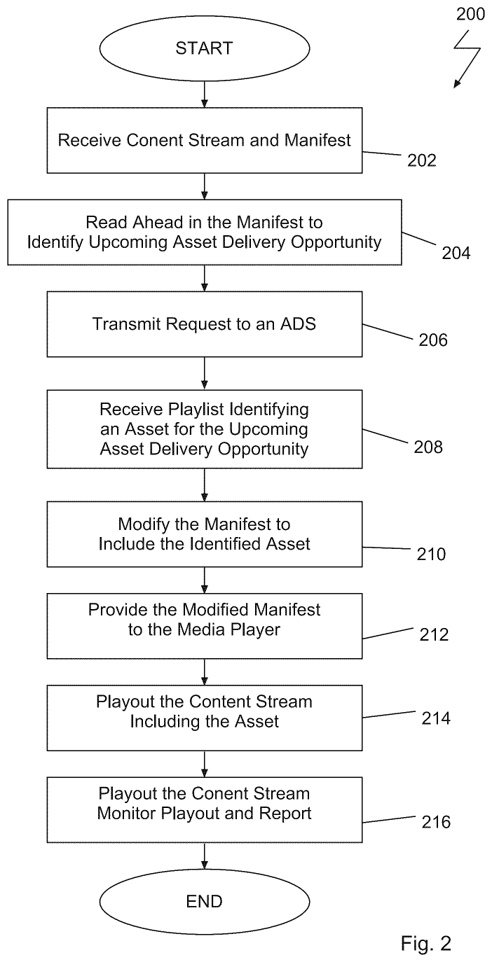

The associated process will now be summarized by reference to the flow chart of FIG. 2. It will be appreciated that FIG. 2 sets forth a specific example of the functionality and the steps, and the ordering of steps, may be varied in particular applications. Moreover, while FIG. 2 focuses on live/linear contexts, it will be appreciated that the invention is applicable in other contexts, such as VOD/DVR and cloud DVR contexts as discussed above.

The process 200 is initiated by receiving (202), at the client device, a content stream and a manifest. In a live/linear context, the manifest may be frequently downloaded and updated, e.g., every few seconds. The manifest manipulator can then read-ahead (204) in the manifest to identify an upcoming asset delivery opportunity. For example, the manifest manipulator may identify a cue indicating an upcoming addressable advertising spot. The manifest manipulator may collect details of the cue such as duration of the asset delivery opportunity and where it is in the manifest (order of segments/periods). Alternatively, in certain contexts such as the cloud DVR context, the system may limit processing to breaks about to be watched. As noted above, depending on the particular implementation, assets may be predetermined by the client device or may be determined in response to receiving a cue. The illustrated implementation, in response to identifying a cue, the client device transmits (206) an asset delivery request to an asset decisioning system. In response, the client device receives (208) a playlist identifying one or more assets for the upcoming asset delivery opportunity.

The client device can then modify (210) the manifest based on the identified asset(s). The process depends on whether there are underlying or default ads in the original content stream. If so, it may be necessary to remove manifest information for the default ads included in the original manifest and replace that default manifest information with manifest information for the identified addressable assets. For example, the portion of the original manifest information corresponding to the underlying ads may be determined based on the length of the original cue and removed. Then, the ad manifest information for the identified addressable ads is inserted in its place by transcoding ad files for the addressable ads into a compatible manifest format and associated MPEG-TS segments. The modified manifest is then provided (212) to the media player of the client device so that, based on the modified manifest, the content player plays out (214) the content stream with the addressable asset in the insertion opportunity. Based on the modified manifest, the client device may access the asset from an asset server including, for example, a Supply Side Platform (SSP) or a Demand Side Platform (DSP). The assets may be obtained in the same format as the content stream.

It will be appreciated that inserting the asset into the content stream in this manner is substantially indistinguishable from playing the content stream with the original default asset in the stream. That is, in either case, from the perspective of the media player, the content stream is assembled based on the content of the manifest. Similarly, the addressable asset delivery will be seamless from the perspective of the user/viewer. The client device can then monitor (216) play out of the content stream and report asset delivery for billing, analysis, or other purposes.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art are within the scope of the present invention. The embodiments described herein above are further intended to explain best modes known of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

1. A method for use in delivering addressable content in content streams, comprising receiving, at a client device from a network content server, a content stream and a manifest concerning content portions of the content stream;
identifying an insertion opportunity for addressable content prior to a time of the insertion opportunity;
responsive to identifying the insertion opportunity, determining an addressable asset for delivery in the insertion opportunity;
generating a modified manifest by modifying the manifest to include manifest information concerning the addressable asset in the insertion opportunity; and
delivering the modified manifest to a content player of the client device;
wherein, based on the modified manifest, the content player plays the content stream with the addressable asset in the insertion opportunity.

2. The method of claim 1, wherein the client device is one of a smart television and a set-top box.

3. The method of claim 1, wherein the client device is one of a desktop computer, a laptop computer, a phone, and a tablet computer.

4. The method of claim 1, wherein the insertion opportunity is associated with a cue identifying an addressable asset delivery opportunity.

5. The method of claim 1, wherein the identifying comprises accessing said manifest to identify said insertion opportunity.

6. The method of claim 1, wherein the determining comprises transmitting a request to a decisioning system and receiving a playlist including the asset.

7. The method of claim 1, further comprising accessing the asset from an asset server the same as or different than the content server.

8. The method of claim 7, wherein said generating comprises replacing manifest information associated with a default asset with modified manifest information associated with the addressable asset.

9. The method of claim 1, further comprising monitoring a delivery of the addressable asset at the client device and providing a report concerning the delivery to a network platform.

10. A system for use in delivering addressable content in content streams, comprising
a client device for receiving, from a network content server, a content stream and a manifest concerning content portions of the content stream, the client device including a manifest manipulator and a content player, wherein;
the manifest manipulator is operative for identifying an insertion opportunity for addressable content prior to a time of the insertion opportunity, determining responsive to identification of the insertion opportunity, an addressable asset for delivery in the insertion opportunity, generating a modified manifest by modifying the manifest to include manifest information concerning the addressable asset, and delivering the modified manifest to the content player of the client device;
wherein, based on the modified manifest, the content player plays the content stream with the addressable asset in the insertion opportunity.

11. The system of claim 10, wherein the client device is one of a smart television and a set-top box.

12. The system of claim 10, wherein the client device is one of a desktop computer, a laptop computer, a phone, and a tablet computer.

13. The system of claim 10, wherein the insertion opportunity is associated with a cue identifying an addressable asset delivery opportunity.

14. The method of claim 10, wherein the identifying comprises accessing said manifest to identify said insertion opportunity.

15. The system of claim 10, wherein the determining comprises transmitting a request to a decisioning system and receiving a playlist including the asset.

16. The system of claim 10, further comprising accessing the asset from an asset server the same as or different from the content server.

17. The system of claim 16, wherein said generating comprises replacing manifest information associated with a default asset with modified manifest information associated with the addressable asset.

18. The system of claim 10, the client device is further operative for monitoring delivery of the asset at the client device and providing a report concerning the delivery to a network platform.

19-30. (canceled)
